(19) United States
(12) Patent Application Publication
(10) Pub. No.: US 2006/0279561 A1
(43) Pub. Date: Dec. 14, 2006

(54) DISPLAY DEVICE

(75) Inventors: Tadafumi OZAKI, Gifu-shi, Gifu-ken (JP); Masami ENDO, Atsugi-shi, Kanagawa-ken (JP)

Correspondence Address: FISH & RICHARDSON P.C., P.O. BOX 1022, MINNEAPOLIS, MN, 55440-1022, US

(73) Assignee: SEMICONDUCTOR ENERGY LABORATORY CO., LTD., Atsugi-shi (JP)

(21) Appl. No.: 11/279,984

(22) Filed: Apr. 17, 2006

(30) Foreign Application Priority Data
Apr. 19, 2005 (JP) 2005-121602

(51) Int. Cl. G09G 5/00

(52) U.S. Cl. 345/204

(57) ABSTRACT

A display device includes a main video data storage means for storing video data; a display mode storage means for storing a display mode; a display mode writing means by which a display mode of a supplied video signal is judged and the judged information is written to the display mode storage means; a video signal reading means by which the video data is read from the main video data storage means to supply to a display panel; a display mode reading means by which the display mode is read from the display mode storage means; and a video signal writing means by which permission or prohibition of writing of the supplied video signal is judged based on the display mode read from the display mode reading means and the video signal is converted to video data which can express a gray scale and written to the main video data storage means.

### BACKGROUND OF THE INVENTION

1. Field of the Invention

The present invention relates to a display device in which a digital video signal is inputted and image display is performed. Particularly, the invention relates to a display device having a light-emitting element. In addition, the invention relates to an electronic apparatus using the display device.

2. Description of the Related Art

There is a display device that is formed of a display panel having a light-emitting element in each pixel and a peripheral circuit for inputting a signal to the display panel, and performs image display by controlling light emission of the light-emitting element.

In such a display device, typically two or three TFTs (thin film transistors) are provided in one pixel, and by controlling on/off of these TFTs, luminance of the light-emitting element and selection of light emission or non-light emission state in each pixel are performed. Although a driver circuit for controlling on/off of the TFTs of each pixel is required, there is a case where the driver circuit is formed over the same substrate of TFTs formed at the same time as the TFTs of the pixel portion.

In a display device of the aforementioned configuration, an analog method or a digital method are typically known for expressing a gray scale in an image display. Among them, the digital method is advantageous in that it is not affected by variations in TFT characteristics. There are a time gray scale method and an area gray scale method as the digital gray scale expression method.

The time gray scale method is a method for expressing a gray scale by controlling time when a light-emitting element of each pixel emits light. When a period for displaying one image is one frame period, one frame period is divided into a plurality of subframe periods. The light-emitting element of each pixel is set to emit light (light emission) or emit no light (non-light emission) in each subframe period and each subframe period is weighted (that is, each subframe period has a different display period). The accumulated period for practically emitting light is controlled by selection thereof (that is, selection of combination of a subframe period during which the light-emitting element in the pixel emits light). Thereby, a gray scale of each pixel is expressed.

On the other hand, the area gray scale method is a method for expressing a gray scale by controlling an area that emits light in each pixel of a display device. Specifically, each pixel is divided into sub-pixels and a gray scale of each pixel is expressed by changing the number of sub-pixels which emits light.

(Related Art)

In a display device expressing a gray scale by the aforementioned time gray scale method or area gray scale method, a control circuit by which a video signal is format-converted to video data for time gray scale display or for area gray scale display is required.

As an example of such a control circuit, a control circuit of a digital time gray scale method is known (for example, see Patent Document 1.). As shown in FIG. 13, this control circuit is composed of a write circuit provided with a format converter 101 by which first video data is converted to second video data for time gray scale, a first video memory 102 and a second video memory 103 storing the second video data, a read circuit provided with a display control portion 104 by which data from the memories is read and transmitted to a display panel, and a selection circuit for selecting the memory for writing data and a memory for reading data. In other words, two memories are used in this control circuit, and one memory is used for reading video data, while the other is used for writing at a certain point.

[Patent Document 1] Japanese Patent Laid-Open No. 2004-163919

### SUMMARY OF THE INVENTION

However, since a video signal is required to be format-converted for a time gray scale display and transmitted to a display panel in the control circuit of a display device using a time gray scale method, video data is required to be stored in the memory once. In a case where all video data is stored in the memory, there has been a problem of increasing power consumption of the memory.

Thus, an object of the invention is to improve operating efficiency of a control circuit which processes signals such as a video signal and a memory included therein. In addition, an object of the invention is to reduce power consumption of a display device.

In the invention, only the video data that is required for display among supplied video data is stored in a video memory in order to achieve the aforementioned object.

A display device of the invention includes a main video data storage means for storing video data, a display mode storage means for storing a display mode, a display mode writing means by which a display mode of a supplied video signal is judged so that judged information is written to the display mode storage means, a video signal reading means by which video data is read from the main video data storage means so that it is supplied to a display panel, a display mode reading means by which a display mode is read from the display mode storage means, and a video signal writing means by which permission or prohibition of writing of the supplied video signal is judged based on the display mode read from the display mode reading means and the video signal is converted to video data which can express a gray scale and written to the main video data storage means.

The video signal reading means may have a configuration including a control means for prohibiting reading a video signal from the main video data storage means based on the judged information stored in the display mode storage means.

Based on a display mode of a video signal, the video signal writing means limits writing or reading of the supplied video signal, thereby operating efficiency of the memory can be improved. Accordingly, power consumption of the display device can be reduced.

### BRIEF DESCRIPTION OF DRAWINGS

FIG. 1 is a block diagram showing a configuration of a display device using the invention.

FIG. 2 is a block diagram showing a configuration of a display device of Embodiment Mode 1 of the invention.

FIG. 3 is a block diagram showing a configuration of a display device of Embodiment Mode 2 of the invention.

FIG. 4 is a circuit diagram showing a compressibility judging circuit in a control circuit of a display device of Embodiment Mode 3 of the invention.

FIG. 5 is a circuit diagram showing a compressibility judging circuit in a control circuit of a display device of Embodiment Mode 4 of the invention.

FIGS. 6A and 6B are diagrams each showing a display device in which a light-emitting element using a material which generates electroluminescence is applied to a pixel to form a display screen.

FIGS. 7A and 7B are diagrams each showing a configuration example of a pixel portion.

FIGS. 8A to 8C are diagrams each showing a configuration example of a pixel portion.

FIG. 9 is a diagram showing a cross section of a pixel composed of a thin film transistor and a light-emitting element connected to the thin film transistor.

FIG. 10 is a diagram showing a display module in which a display panel and a display control circuit are combined.

FIG. 11 is a diagram showing one configuration example of a mobile phone device related to the invention.

FIG. 12 is a view showing one configuration example of a TV set related to the invention.

FIG. 13 is a block diagram showing a conventional display device control circuit.

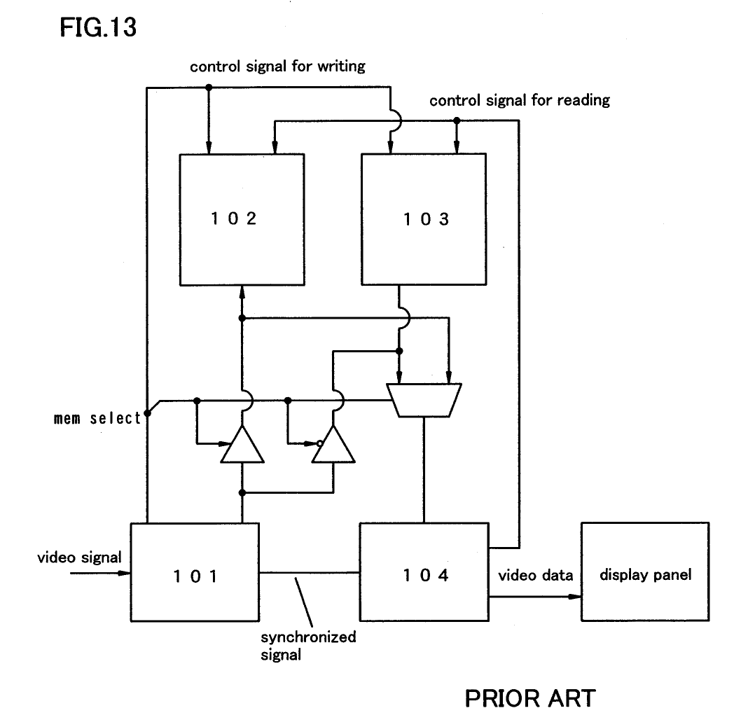

### DETAILED DESCRIPTION OF THE INVENTION

Embodiment Mode

Although the present invention will be fully described by way of embodiment modes with reference to the accompanying drawings, it is to be understood that various changes and modifications will be apparent to those skilled in the art. Therefore, unless such changes and modification depart from the scope of the present invention, they should be construed as being included therein.

(Embodiment Mode 1)

In the case of low gray scale display, the amount of video data transferred to a display panel can be reduced compared to a case where all gray scales are required to be expressed. For example, in a case of the same value for i bits (i is an integral number of two or more) among video data, video data for one bit among the video data for i bits may be held in a video memory. There is a plurality of combination of i, and the combination is referred to as a display mode hereinafter.

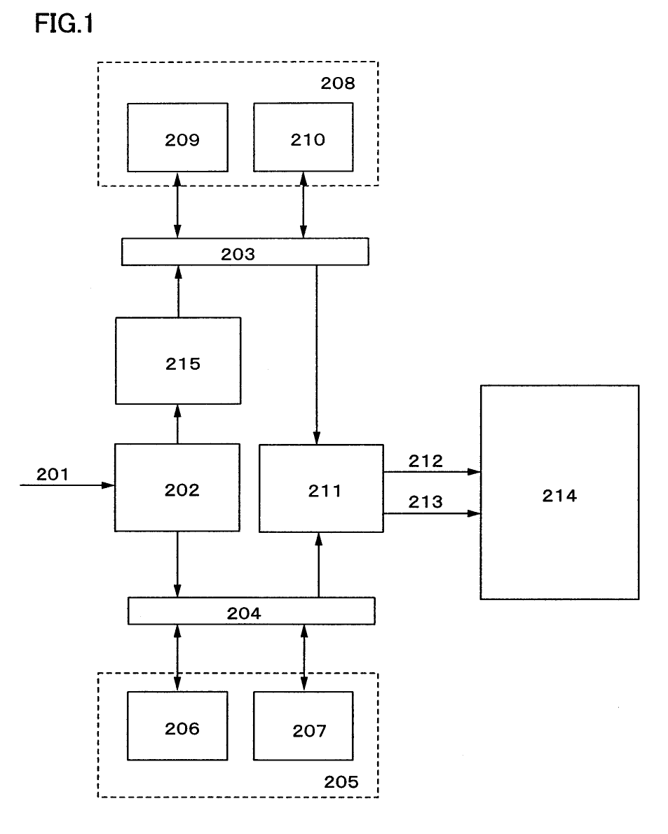

A configuration of a display device related to the invention is described with reference to FIG. 1. First, information that i bits (i is an integral number) among received video data 201 have the same value is judged by a display mode judging circuit 202 and a judged result is, as a display mode, stored in a display mode register 205 through a second selector 204.

The display mode register 205 includes a first display mode register 206 and a second display mode register 207, the judged display mode described above is stored in the first display mode register 206 in the n-th (n is a natural number) frame and stored in the second display mode register 207 in the (n+1)-th frame by the control of the second selector 204.

The video data is inputted to a format conversion circuit 215 to be format-converted for time gray scale display, and stored in a video memory 208. At this time, by the control of a first selector 203, the video data is stored in a first video memory 209 in the n-th frame, and stored in a second video memory 210 in the (n+1)-th frame. At writing of video data to the video memory 208, writing is not performed in a case where writing is not required to the first video memory 209, depending on the judged display mode. Specifically, in a case where video data for i bits is the same value to each other, video data for one bit among the video data for i bits may be held in the video memory 208, and writing of video data for remaining (i−1) bits can be omitted.

In a display control circuit 211, a display mode is read from the display mode register 205, a display control signal 212 is produced based on the display mode to transmit to a display panel 214, and at the same time, video data is read from the video memory 208 to operate to transmit to the display panel 214 as transmission video data 213. At this time, if video data is not required to be read from the video memory 208 depending on the display mode read from the display mode register 205, reading operation is not performed. Specifically, in a case of reading video data, when a plurality of pixels has the same video data in adjacent pixels, after video data is read from a first pixel among the plurality of pixels, the video data of the plurality of pixels is not read, and the number of readings from the video memory 208 can be reduced using the read video data. Note that information of the number of adjacent pixels which has the same video data value can be obtained by the display mode read from the display mode register 205.

Note that in the aforementioned description, description is made such that the display mode register 205 is distinguished from the video memory 208, but a display mode and video data may be stored over the same chip.

A configuration shown in FIG. 1 can be applied to an active matrix display device in which an electroluminescence light-emitting element is provided in a pixel portion and the light-emitting element is operated by a transistor. Moreover, the configuration can also be applied to a passive matrix display device in which an electroluminescence light-emitting element is provided in a pixel portion. In addition, the configuration can also be applied to a plasma display.

In this display device control circuit, for example, in a case where video data is equivalent among a plurality of pixels or a case where a bit value of video data is equivalent partially, only one of the plurality of pixels or the bit value of the plurality of video data may be stored in the video memory, the number of access to the memory can be reduced to contribute to low power consumption.

(Embodiment Mode 2)

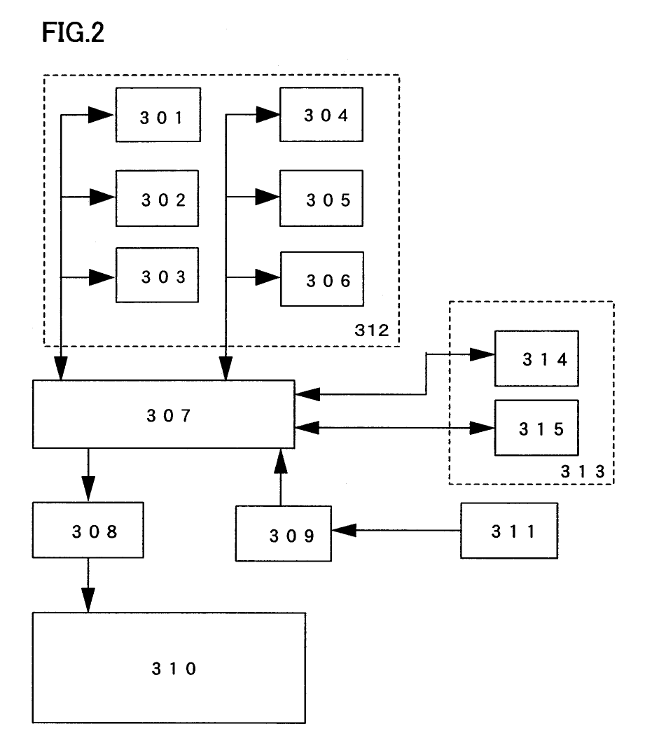

In this embodiment mode, description is made on an example of a circuit in which video data is compressed and encoded, and a memory region is changed by a difference of compressibility to use a video memory with reference to FIG. 2.

First, video data is supplied from a CPU 311 and inputted to a format conversion compression circuit 309. In the format conversion compression circuit 309, format conversion of video data is performed for gray scale display, comparison of a value of each video bit and comparison of a value of video data corresponding to a certain pixel to a value of video data corresponding to another pixel are performed, and the video data is compressed and compressibility is obtained based on the comparison result. The video data compressed in the compressing operation is inputted to a memory controller 307 and written to a video memory 312. For example, when one or a plurality of bit values is equal to each other among video data bit values corresponding to a first pixel group to a k-th pixel group in succession (integral number of k>1), video data is compressed by a extracting a value of k and only a video data bit value equal in one pixel group among the first pixel group to the k-th pixel group. Note that an order to perform the format conversion operation and the compressing operation is not limited and the conversion operation and the compressing operation may be simultaneously performed. The compressibility obtained by the aforementioned operation is stored in a display mode register 313.

Here, a region of a memory to which video data is written is described. In a case where video data is not compressed, video data is stored in a first video memory 301 and a fourth video memory 304. Meanwhile, in a case where video data is compressed, video data is stored in a second video memory 302, a third video memory 303, a fifth video memory 305, and a sixth video memory 306.

By changing the memory region for storing depending on a difference in compressibility, a compressing method of video data is changed into the most favorable one so that the amount of video data is minimized and a data format in one address is changed depending on a difference in compressibility; thereby the amount of video data transferred can be reduced more efficiently.

Moreover, in a case where video data is compressed, when the compression is exceeds a certain compressibility, the video data is stored in the fifth video memory 305 or the sixth video memory 306. Meanwhile, when the compression is below the certain compressibility, the video data is stored in the second video memory 302 or the third video memory 303.

Note that the first video memory 301 to the sixth video memory 306 may be formed over the same chip, or may be formed over different chips.

Next, a display control signal is produced in a display control circuit 308 and transmitted to a display panel 310, and at the same time, compressibility information is read from the display mode register 313, then based on the compressibility, an address region of the video memory 312 for reading video data is judged, video data is read from the video memory 312 through the memory controller 307 in synchronism with displaying, and in the display control circuit 308, the read and compressed video data is restored to be transmitted to the display panel 310.

In the aforementioned operation, the first video memory 301 to the third video memory 303 are used for writing video data in a certain frame period while the fourth video memory 304 to the sixth video memory 306 are used for reading video data, and both roles are inverted in the next frame period. Moreover, in a certain frame period, a first display mode register 314 is used for writing compressibility and a second display mode register 315 is used for reading, and both roles are inverted in the next frame period.

By the configuration of this embodiment mode, the amount of writing/reading to/from the video memory 312 can be reduced to be contributed to low power consumption.

(Embodiment Mode 3)

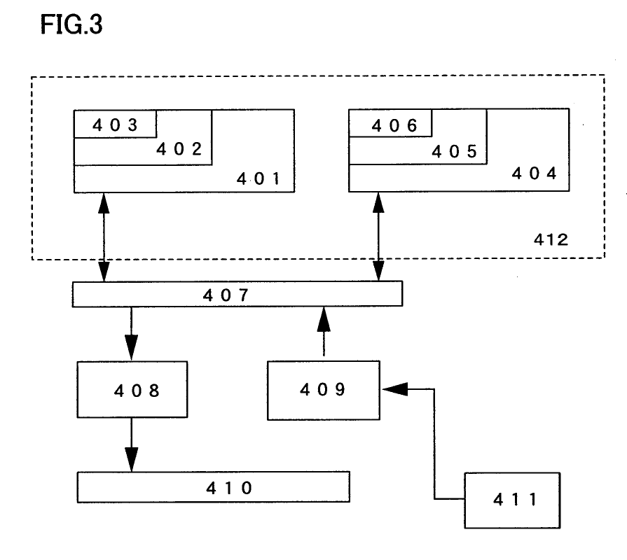

FIG. 3 shows an example in which a memory space of one memory chip or an address is divided and restructured. Although memories are separately provided in FIG. 2, a memory space of one memory chip or an address is divided to be used. The relationship of the bit numbers of a first video memory region 401 to a sixth video memory region 406 is as follows: the first video memory region 401=the fourth video memory region 404>the second video memory region 402=the fifth video memory region 405>the third video memory region 403=the sixth video memory region 406.

The second video memory region 402 and the third video memory region 403 are formed in the first video memory region 401, while the fifth video memory region 405 and the sixth video memory region 406 are formed in the fourth video memory region 404.

Next, an operation of a display device shown in FIG. 3 is described. First, data is transmitted from a CPU 411 to a format conversion compression circuit 409 and format conversion for a time gray scale of image data is performed, and at the same time, comparison of a value of each video bit and comparison of a value of video data corresponding to a certain pixel to a value of video data corresponding to another pixel are performed, and the video data is compressed and compressibility is obtained based on the comparison result. For example, when one or a plurality of bit values is equal to each other among video data bit values corresponding to a first pixel group to a k-th pixel group in succession (integral number of k>1), the video data is compressed by extracting a value of k and only a video data bit value equal in one pixel group among the first pixel group to the k-th pixel group. Based on the compressibility obtained by the operation, the first video memory region 401 to the third video memory region 403 or the fourth video memory region 404 to the sixth video memory region 406 in a video memory region 412 are selected by a memory controller 407 and the video data is written thereto. A display control signal produced in a display control circuit 408 is transmitted to a display panel 410.

Similarly to the above description, received video data is compressed and held in a video memory, so that the number of access to the memory can be reduced to be contributed to low power consumption.

(Embodiment Mode 4)

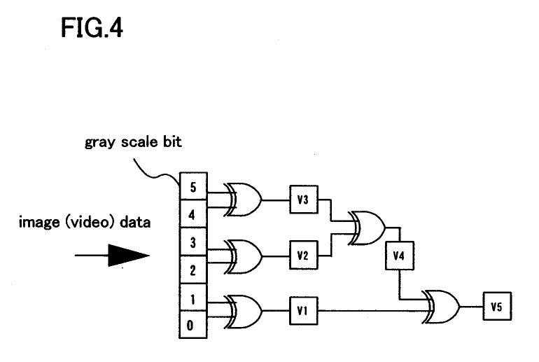

An example of a compression decision circuit for a gray scale of image data related to the invention is described with reference to FIG. 4.

FIG. 4 shows a state in which image data with 6-bit gray scale is inputted to a compression decision circuit. First, image data with 6-bit gray scale is inputted, an exclusive OR (hereinafter referred to as EXOR) of the 0-th bit to the 5-th bit is obtained. At this time, the respective results are denoted by V1, V2, and V3. Moreover, an EXOR of V2 and V3 is denoted by V4, and an EXOR of V4 and V1 is denoted by V5. In a case where all of V1, V2, and V3 are 1, the number of gray scales to be used is 3 bits and the image data can be compressed by one-half Further, since an image is 1 bit of white and black in a case where V5 is 1, the image data can be compressed by one-sixth.

Similarly to the above description, received video data is compressed and held in a video memory, so that the number of access to the memory can be reduced to be contributed to low power consumption.

(Embodiment Mode 5)

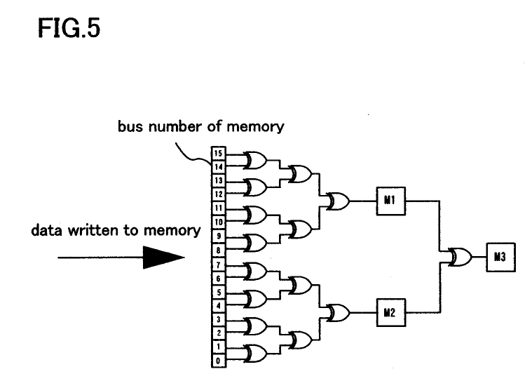

This embodiment mode describes an example of a compression decision circuit for a bus direction to which image data is written to a memory, an address direction to which image data is written to a memory, a pixel direction or RGB with reference to FIG. 5.

For a direction of adjacent buses, adjacent addresses, or adjacent pixels, or RGB, an EXOR is performed, and the EXOR is repeated further for the judged results adjacent to each other, so that judged results of M1 and M2 are obtained. Further, the EXOR of M1 and M2 is performed and a judged result of M3 is obtained. In a case where the results of M1 and M2 are 1, video data can be compressed by one-eighth for 8 bus directions (address, pixel, or RGB directions). Moreover, in a case where the result of M3 is 1, video data can be considered to be compressed by one-16th for 16 bus directions (address, pixel, or RGB directions). Compressibility of image data is judged based on these results.

(Embodiment Mode 6)

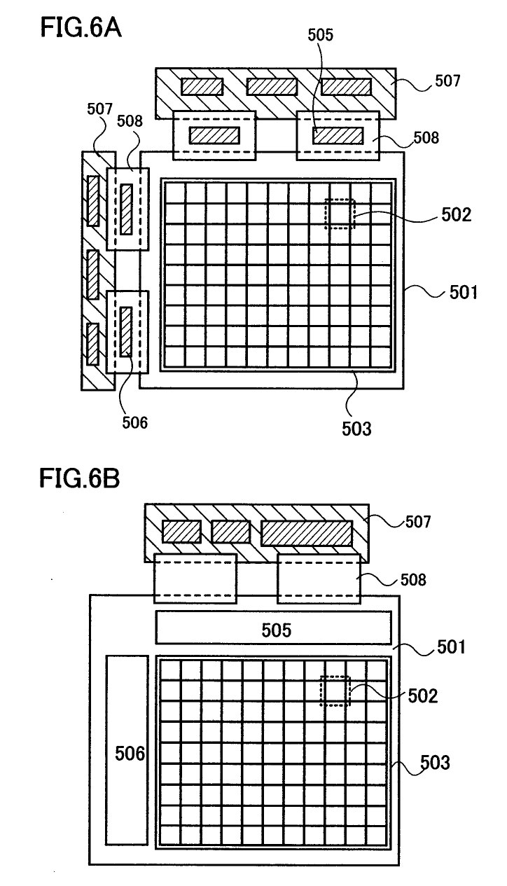

This embodiment mode describes a display device in which a light-emitting element using a material which generates electroluminescence is applied to a pixel to form a display screen with reference to FIGS. 6A and 6B.

In FIG. 6A, a display panel has a pixel portion 503 formed of a plurality of pixels 502 arranged in matrix. Each pixel 502 is provided with a switching element such as a thin film transistor and a light-emitting element connected thereto. An input terminal is provided at the end of a substrate 501. A display control circuit 507 described in Embodiment Modes 1 to 4 is connected to an end of this input terminal with connection wires 508. On the connection wires 508, a driver IC forming a signal driver circuit 505 and a scan driver circuit 506 may be mounted.

A configuration in which the signal driver circuit 505 and the scan driver circuit 506 are provided over the same substrate as the substrate that the pixel portion 503 is formed as shown in FIG. 6B can be used as another mode. These driver circuits can be formed of a p-channel and an n-channel thin film transistors which are the same as a thin film transistor included in the pixel 502. In this case, a channel forming region of the thin film transistor is preferably formed of a polycrystalline semiconductor. Moreover, a configuration in which a driver IC in which the driver circuit is formed is mounted on the substrate 501 may be used.

Low power consumption can be achieved in such a display device by combining with the display control circuit described in Embodiment Modes 1 to 4.

(Embodiment Mode 7)

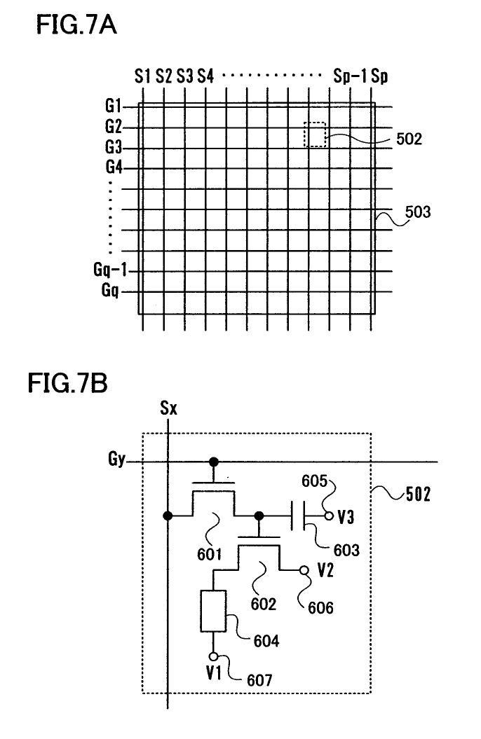

FIG. 7A shows a configuration example of the pixel portion 503 shown in FIG. 6A and FIG. 6B (hereinafter referred to as a first pixel configuration). A plurality of signal lines S₁ to Sₚ (p is a natural number) and a plurality of scan lines G₁ to G_{q} (q is a natural number) so as to intersect with the plurality of signal lines S₁ to Sₚ are provided in the pixel portion 503. Moreover, pixels are provided at respective intersections between the signal lines S₁ to Sₚ and the scan lines G₁ to G_{q}. In this case, the pixel 502 denotes a region including a compartmentalized region surrounded by the signal line and the scan line.

FIG. 7B shows a configuration of the pixel 502 of FIG. 7A. FIG. 7B shows the pixel 502 formed at an intersection between an Sₓ (x is a natural number equal to or less than p) which is one of the plurality of signal lines S₁ to Sₚ and a G_{y} (y is a natural number equal to or less than q) which is one of the plurality of scan lines G₁ to G_{q}. The pixel 502 has a first transistor 601, a second transistor 602, a capacitor 603, and a light-emitting element 604. Note that in this embodiment, an example using the element which has a pair of electrodes and emits light when current flows between the pair of electrodes, as the light-emitting element 604, is shown. In addition, parasitic capacitance of the second transistor 602 or the like may be positively used as the capacitor 603. An n-channel transistor or a p-channel transistor may be used for the first transistor 601 and the second transistor 602. A thin film transistor can be used as the transistor forming the pixel 502.

A gate of the first transistor 601 is connected to the signal line Sₓ, one of a source and a drain of the first transistor 601 is connected to the scan line G_{y}, and the other thereof is connected to a gate of the second transistor 602 and one electrode of the capacitor 603. The other electrode of the capacitor 603 is connected to a terminal 605 to which a potential V₃ is applied. One of a source and a drain of the second transistor 602 is connected to one electrode of the light-emitting element 604, and the other thereof is connected to a terminal 606 to which a potential V₂ is applied. The other electrode of the light-emitting element 604 is connected to a terminal 607 to which a potential V₁ is applied.

An operation of the pixel 502 having such a configuration can be described as follows. One of the plurality of scan lines G₁ to G_{q} is selected, and while the scan line is selected, a video signal is inputted to all of the plurality of signal lines S₁ to Sₚ, Thus, the video signal is inputted to pixels of one row of the pixel portion 503. The plurality of scan lines G₁ to G_{q} is selected sequentially, and similar operation is performed, so that the video signal is inputted to all the pixels 502 of the pixel portion 503.

Description is made on an operation of the pixel 502 in which G_{y} which is one of the pluralities of scan lines G₁ to G_{q} is selected and the video signal is inputted from Sₓ which is one of the pluralities of signal lines S₁ to Sₚ, When the scan line G_{y} is selected, the first transistor 601 becomes ON state. ON state of a transistor means that the source and the drain are electrically connected, while OFF state of the transistor means that the source and the drain are not electrically connected. When the first transistor 601 becomes ON state, a video signal inputted to the signal line Sₓ is inputted to the gate of the second transistor 602 through the first transistor 601. In the second transistor 602, ON state or OFF state is selected in accordance with the inputted video signal. When ON state of the second transistor 602 is selected, drain current of the second transistor 602 flows to the light-emitting element 604 and the light-emitting element 604 emits light.

A potential V₂ and a potential V₃ are kept such that a potential difference between them is always constant when the second transistor 602 becomes ON state. The potential V₂ and the potential V₃ may be the same potential. In a case where the potential V₂ and the potential V₃ are the same potential, the terminal 605 and the terminal 606 may be connected to the same wire. The potential V₁ and the potential V₂ are set to have a predetermined potential difference when light emission of the light-emitting element 604 is selected. Thus, current flows through the light-emitting element 604 and the light-emitting element 604 emits light.

In a display device having such a pixel portion 503, low power consumption can be achieved by combining with the display control circuit described in Embodiment Modes 1 to 4.

(Embodiment Mode 8)

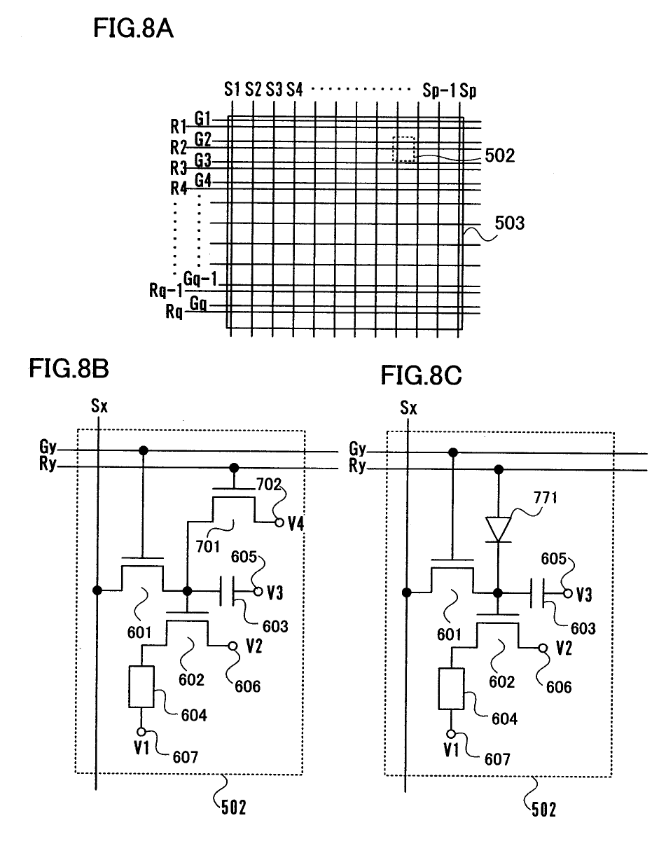

FIG. 8A shows another configuration example of the pixel portion 503 shown in FIG. 6A and FIG. 6B. The pixel portion 503 has a plurality of first signal lines S₁ to Sₚ (p is a natural number), a plurality of scan lines G₁ to G_{q} (q is a natural number) provided so as to intersect with the plurality of signal lines S₁ to S_{P}, a plurality of scan lines R₁ to R_{q}, and the pixels 502 provided at respective intersections between the signal lines S₁ to Sₚ and the scan line G₁ to G_{q}.

FIG. 8B shows a configuration of the pixel 502 of FIG. 8A. FIG. 8B shows the pixel 502 formed at an intersection between an Sₓ (x is a natural number equal to or less than p) which is one of the plurality of signal lines S₁ to Sₚ, and a G_{y} (y is a natural number equal to or less than q) which is one of the plurality of scan lines G₁ to G_{q} and an R_{y} which is one of the plurality of scan lines R₁ to R_{q}. Note that in the pixel configuration shown in FIG. 8B, the same reference numerals are used for the same portions as in FIG. 7B and description thereof is omitted. There is a difference in that FIG. 8B has a third transistor 701 in the pixel 502 shown in FIG. 7B. An n-channel transistor or a p-channel transistor may be used for the third transistor 701. A thin film transistor can be used as the transistor forming the pixel 502.

A gate of the third transistor 701 is connected to the scan line R_{y}, one of a source and a drain of the third transistor 701 is connected to the gate of the second transistor 602 and one electrode of the capacitor 603, and the other thereof is connected to a terminal 702 to which a potential V₄ is applied.

There is a characteristic in that the light-emitting element 604 of the pixel 502 can emit no light regardless of the video signal inputted from the signal line Sₓ by having the scan line R_{y} and the third transistor 701 in the pixel of configuration shown in FIG. 8A and FIG. 8B. A signal inputted to the scan line R_{y} can set the time when the light-emitting element 604 of the pixel 502 emits light. Thus, the scan lines G₁ to G_{q} are selected sequentially, and a light emission period shorter than a period during which all the scan lines G₁ to G_{q} are selected can be set. Thus, in a case where display is performed by a time division gray scale method, a short sub-frame period can be set; therefore, a high gray scale can be expressed.

The potential V₄ may be set so that the second transistor 602 is OFF state when the third transistor 701 is ON state. For example, when the third transistor 701 is ON state, the potential V₄ can be set at the same potential as the potential V₃. The potential V₃ and the potential V₄ are set at the same potential so that charge held in the capacitor 603 is discharged, a gate-source voltage of the second transistor 602 is made zero, and the second transistor 602 can be OFF state. Note that in a case where the potential V₃ and the potential V₄ are set at the same potential, the terminal 605 and the terminal 702 may be connected to the same wire.

Note that the third transistor 701 is not limited to the arrangement shown in FIG. 8B. For example, the third transistor 701 may be arranged in series with the second transistor 602. In this configuration, the third transistor 701 is made OFF state by a signal inputted to the scan line R_{y}; therefore, current flowing to the light-emitting element 604 is intercepted and the light-emitting element 604 can emit no light.

A diode can be used in substitution for the third transistor 701 shown in FIG. 8B. FIG. 8C shows a pixel configuration using a diode in substitution for the third transistor 701. Note that in FIG. 8C, the same reference numerals are used for the same portions as in FIG. 8B and description thereof is omitted. One electrode of a diode 771 is connected to the scan line R_{y}, and the other electrode thereof is connected to the gate of the second transistor 602 and one electrode of the capacitor 603.

The diode 771 passes current from one electrode to the other electrode. The second transistor 602 is a p-channel transistor. By increasing a potential of one electrode of the diode 771, a gate potential of the second transistor 602 is increased and the second transistor 602 can be OFF state.

FIG. 8C shows the configuration in which the p-channel transistor is used as the second transistor 602, and the diode 771 passes current from one electrode connected to the scan line R_{y} to the other electrode connected to the gate of the second transistor 602, but the invention is not limited to this. A configuration in which an n-channel transistor is used as the second transistor 602, and the diode 771 passes current from the other electrode connected to the gate of the second transistor 602 to one electrode connected to the third signal line R_{y} may be used. In a case where the second transistor 602 is the n-channel transistor, a potential of one electrode of the diode 771 is decreased; thereby, the gate potential of the second transistor 602 is decreased and the second transistor 602 can be OFF state.

A diode-connected transistor may be used for the diode 771. The diode-connected transistor means a transistor in which a drain and a gate are connected. A p-channel transistor or an n-channel transistor may be used for the diode-connected transistor.

In a display device having such a pixel portion 503, low power consumption can be achieved by combining with the display control circuit described in Embodiment Modes 1 to 4.

(Embodiment Mode 9)

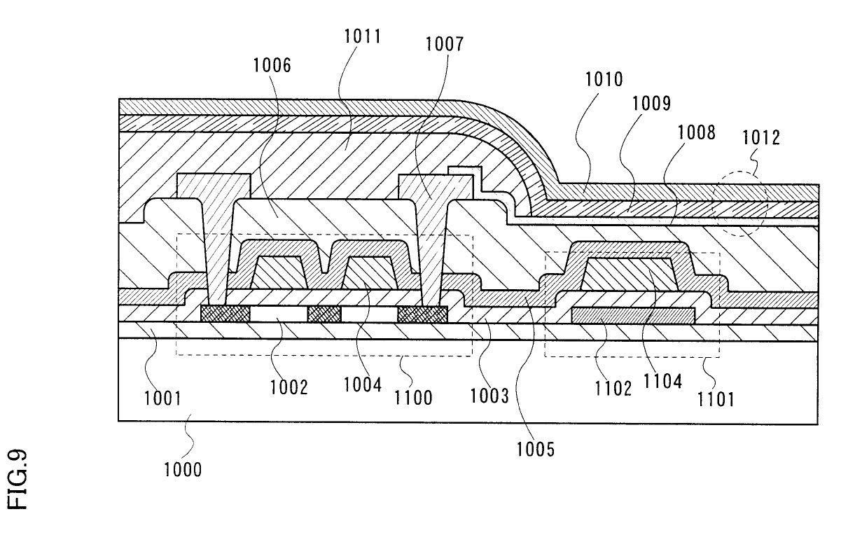

One mode of a pixel configuration of the display device described in Embodiment Modes 6 to 8 is described with reference to FIG. 9. FIG. 9 is a cross-sectional view of a pixel formed of a thin film transistor and a light-emitting element connected thereto.

In FIG. 9, a semiconductor layer 1002 forming a base film 1001 and a thin film transistor 1100, and a semiconductor layer 1102 forming one electrode of a capacitor 1101 are formed over a substrate 1000. A first insulating layer 1003 is formed over the semiconductor layers 1002 and 1102, and functions as a gate insulating layer in the thin film transistor 1100 and as a dielectric layer for forming capacitance in the capacitor 1101.

A gate electrode 1004 and a conductive layer 1104 forming the other electrode of the capacitor 1101 are formed over the first insulating layer 1003. A wire 1007 connected to the thin film transistor 1100 is connected to a first electrode 1008 of a light-emitting element 1012. The first electrode 1008 is formed over a third insulating layer 1006. A second insulating layer 1005 may be formed between the first insulating layer 1003 and the third insulating layer 1006. The light-emitting element 1012 is formed of the first electrode 1008, an EL layer 1009, and a second electrode 1010. Moreover, a fourth insulating layer 1011 is formed so as to cover a peripheral edge portion of the first electrode 1008 and a connecting portion between the first electrode 1008 and the wire 1007.

Next, details of the configuration described in the above are described. As the substrate 1000, for example, a glass substrate such as barium borosilicate glass or aluminoborosilicate glass, a quartz substrate, a ceramic substrate, or the like can be used. Moreover, an insulating film is formed on the surface of a metal substrate including stainless or of a semiconductor substrate, which may be used. A substrate formed of a synthetic resin having flexibility such as plastic may be used as well. A surface of the substrate 1000 may be planarized by polishing such as a chemical mechanical polishing (CMP) method.

As the base film 1001, an insulating film such as silicon oxide, silicon nitride, or silicon nitride oxide can be used. The base film 1001 can prevent an alkaline metal such as Na or an alkaline earth metal included in the substrate 1000 from diffusing in the semiconductor layer 1002 and causing adverse effect on the property of the thin film transistor 1100. In FIG. 9, the base film 1001 is a single-layer structure but may be formed of two layers or a plurality of layers more than two layers. Note that in a case where diffusion of impurities does not become a problem, such as a quartz substrate, the base film 1001 is not necessarily provided.

A crystalline semiconductor film formed in an island shape is preferably used for the semiconductor layer 1002 and the semiconductor layer 1102. The crystalline semiconductor film can be obtained by crystallizing an amorphous semiconductor film. As a crystallization method, a laser crystallization method, a thermal crystallization method using RTA or an annealing furnace, a thermal crystallization method using a metal element to promote crystallization, or the like can be used. The semiconductor layer 1002 has a channel forming region and a pair of impurity regions to which an impurity element giving one conductivity type is doped. Note that the semiconductor layer 1002 may also have an impurity region to which the impurity element is doped in low concentration between the channel forming region and the pair of impurity regions. A structure in which an impurity element giving one conductivity type or a conductivity type which is reverse to it is doped to the whole of the semiconductor layer 1102 can be used.

Silicon oxide, silicone nitride, silicon nitride oxide, or the like is used and a single layer or a plurality of films is stacked so that the first insulating layer 1003 can be formed. In this case, oxidation or nitriding treatment may be performed to a surface of the insulating film by high-density plasma treatment excited by microwave to be densified. This treatment may be performed before the film formation of the first insulating layer 1003. Thus, a good boundary between the semiconductor and the insulating layer can be formed.

For the gate electrode 1004 and the conductive layer 1104, a single-layer or a stacked structure formed of an alloy or a compound including element of a kind selected from Ta, W, Ti, Mo, Al, Cu, Cr, and Nd, or a plurality of the elements can be used.

The thin film transistor 1100 is formed of the semiconductor layer 1002, the gate electrode 1004, and the first insulating layer 1003 between the semiconductor layer 1002 and the gate electrode 1004. FIG. 9 shows the thin film transistor 1100 forming a pixel, which is connected to the first electrode 1008 of the light-emitting element 1012. The thin film transistor 1100 has a multi-gate structure in which a plurality of the gate electrodes 1004 is arranged over the semiconductor layer 1002. That is, the thin film transistor has a structure in which a plurality of transistors is connected in series. Such a structure can suppress the increase of unnecessary off current. Note that FIG. 9 shows the thin film transistor 1100 as a top-gate transistor, but a bottom-gate transistor having a gate electrode below a semiconductor layer may be used, or a dual-gate transistor having gate electrodes above and below a semiconductor layer may be used.

The capacitor 1101 is formed of the first insulating layer 1003 as a dielectric, and the semiconductor layer 1102 and the conductive layer 1104 as a pair of electrodes which face each other by sandwiching the first insulating layer 1003. Note that FIG. 9 shows an example in which as to a capacitor provided in a pixel, one of the pair of electrodes is the semiconductor layer 1102 formed at the same time with the semiconductor layer 1002 of the thin film transistor 1100, and the other conductive layer 1104 is formed at the same time with the gate electrode 1004. However, the invention is not limited to this configuration.

The second insulating layer 1005 is desirable to be an insulating film with barrier properties for blocking an ionic impurity, such as a silicon nitride film. An inorganic insulating film or an organic insulating film can be used for the third insulating layer 1006. A silicon oxide film formed by CVD, an SOG (Spin On Glass) film (coating silicon oxide film), or the like can be used for the inorganic insulating film. A film of, for example, polyimide, polyamide, BCB (benzocyclobutene), acrylic, a positive photosensitive organic resin, or a negative photosensitive organic resin can be used for the organic insulating film. Moreover, a material which is composed of a skeleton formed by the bond of silicon (Si) and oxygen (O) can be used for the second insulating layer 1006. An organic group containing at least hydrogen (such as an alkyl group, or aromatic hydrocarbon) is used as a substituent of this material. Alternatively, a fluoro group may be used as the substituent. Further alternatively, an organic group containing at least hydrogen and a fluoro group may be used as the substituent.

For the wire 1007, a single-layer or a stacked structure formed of an alloy including element of a kind selected from Al, Ni, C, W, Mo, Ti, Pt, Cu, Ta, Au, and Mn, or a plurality of the elements can be used.

One or both of the first electrode 1008 and the second electrode 1010 can be set a transparent electrode. For the transparent electrode, indium oxide including tungsten oxide (IWO), indium zinc oxide including tungsten oxide (IWZO), indium oxide including titanium oxide (ITiO), indium tin oxide including titanium oxide (ITTiO), indium tin oxide including molybdenum (ITMO), or the like can be used. Of course, indium tin oxide (ITO), indium zinc oxide (IZO), indium tin oxide added with silicon oxide (ITSO), or the like can be used.

At least one of the first electrode 1008 and the second electrode 1010 may be formed of a material which does not have light transmissivity. For example, an alkaline metal such as Li or Cs, an alkali earth metal such as Mg, Ca, or Sr, an alloy (Mg: Ag, Al: Li, Mg: In or the like) including them, a compound of them (CaF₂, Ca₃N₂), or a rare earth metal such as Yb or Er can be used.

The fourth insulating layer 1011 can be formed using a similar material to the third insulating layer 1006.

The light-emitting element 1012 is formed of the EL layer 1009, the first electrode 1008 and the second electrode 1010 sandwiching the EL layer 1009. One of the first electrode 1008 and the second electrode 1010 corresponds to an anode, while the other corresponds to a cathode. When a voltage higher than a threshold voltage is applied between the anode and the cathode in forward bias direction, current flows from the anode to the cathode; thereby, the light-emitting element 1012 emits light.

The EL layer 1009 is formed of single or a plurality of layers. In a case of forming with a plurality of layers, these layers can be classified in a hole injection layer, a hole transporting layer, a light emitting layer, an electron transporting layer, an electron injection layer, or the like from the viewpoint of a carrier transporting property. Note that a boundary of each layer is not required to be clear, and there is a case where respective materials forming the layers are mixed partly and the boundary between them becomes indistinct. A material of organic system or a material of inorganic system can be used for each layer. As the material of organic system, any material of high molecular system, middle molecular system, or low molecular system can be used.

The EL layer 1009 is preferably formed using a plurality of layers with different functions such as a hole injection transporting layer, or a light-emitting layer, an electron injection transporting layer. The hole injection transporting layer is preferably formed of a composite material including an organic compound material with a hole transporting property, and an inorganic compound material having an electron-accepting property against the organic compound material. Many hole carriers are generated in the organic compound which originally has almost no internal carrier and extremely superior hole injection property/transporting property can be obtained with such a configuration. This effect can lower a driving voltage than a conventional driving voltage. In addition, since the hole injection transporting layer can be thickened without increasing the driving voltage, short circuit of the light-emitting element due to dust or the like can be suppressed.

For the organic compound material with a hole transporting property, for example, there are copper phthalocyanine (abbreviated: CuPc), 4,4′,4″-tris[N-(3-methylphenyl)-N-phenylamino]triphenylamine (abbreviated: MTDATA), 1,3,5-tris[N,N-di(m-tolyl)amino]benzene (abbreviated: m-MTDAB), N,N′-diphenyl-N, N′-bis(3-methylphenyl)-1,1′-biphenyl-4,4′-diamine (abbreviated: TPD), 4,4′-bis[N-(1-naphthyl)-N-phenylamino]biphenyl(abbreviated: NPB), 4,4′-bis{N-[4-di(m-tolyl)amino]phenyl-N-phenylamino}biphenyl (abbreviated: DNTPD), and the like, but the invention is not to be limited to them.

For the inorganic compound material showing an electron-accepting property, there are titanium oxide, zirconium oxide, vanadium oxide, molybdenum oxide, tungsten oxide, rhenium oxide, ruthenium oxide, zinc oxide, and the like. Vanadium oxide, molybdenum oxide, tungsten oxide, and rhenium oxide are particularly suitable since vacuum evaporation is possible and they are easy to handle.

The electron injection transporting layer is formed of an organic compound material with an electron transporting property. Specifically, there are tris(8-quinolinolato)aluminum (abbreviated: Alq₃), tris(4-methyl-8-quinolinolato)aluminum (abbreviated: Almq₃), bis(2-methyl-8-quinolinolato)(4-phenylphenolato)aluminum (abbreviated: BAlq), bathocuproin (abbreviated: BCP), 2-(4-biphenylyl)-5-(4-tert-buthylphenyl)-1,3,4-oxadiazole (abbreviated: PBD), 3-(4-biphenylyl)-4-phenyl-5-(4-tert-butylphenyl)-1,2,4-triazole (abbreviated: TAZ), and the like, but the invention is not limited to them.

For the EL layer, there are 9,10-di(2-naphthyl)anthracene (abbreviated: DNA), 9,10-di(2-naphthyl)-2-tert-butylanthracene (abbreviated: t-BuDNA), 4,4′-bis(2,2-diphenylvinyl)biphenyl (abbreviated: DPVBi), coumarin 30, coumarin 6, coumarin 545, coumarin 545T, perylene, rubrene, periflanthene, 2,5,8,11-tetra(tert-butyl)perylene (abbreviated: TBP), 9,10-diphenylanthracene (abbreviated: DPA), 5,12-diphenyltetracene, 4-(dicyanomethylene)-2-methyl-6-[p-(dimethylamino)styryl]-4H-pyran (abbreviated: DCM1), 4-(dicyanomethylene)-2-methyl-6-[2-julolidine-9-yl)-ethenyl]-4H-pyran (abbreviated: DCM2), and the like. Further, a compound which can generate phosphorescence such as bis{2-[3′,5′-bis(trifluoromethyl)phenyl]pyridinato-N,C^{2′}}iridium(picolinate) (abbreviated: Ir(CF₃ppy)₂(pic)), tris(2-phenylpyridinato-N,C^{2′})iridium (abbreviated: Ir(ppy)₃), bis(2-phenylpyridinato-N,C^{2′})iridium(acetylacetonato) (abbreviated: Ir(ppy)₂(acac)), bis[2-(2′-thienyl)pyridinato-N,C^{3′}]iridium(acetylacetonate) (abbreviated: Ir(thp)₂(acac)), and bis(2-phenylquinolinato-N,C^{2′})iridium(acetylacetonate) (abbreviated: Ir(pq)₂(acac)) can be used.

Moreover, a triplet excited light-emitting material including a metal complex or the like may be used for the light-emitting layer, in addition to a singlet excited light-emitting material. For example, a pixel emitting red light whose luminance is reduced by half in a relatively short time is formed of the triplet excited light emitting material, and the pixels emitting green and blue light are formed of the singlet excited light emitting material. Since the triplet excited light-emitting material has an excellent light emitting efficiency, it has a feature of requiring lower power to obtain the same level of luminance as compared with the singlet excited light emitting material. That is, when the pixel emitting red light is formed of the triplet excited light-emitting material, only a small amount of current is required to flow through the light-emitting element; thereby improving reliability. To reduce power consumption, the pixels emitting red and green light may be formed of the triplet excited light-emitting material, while the pixel emitting blue light may be formed of the singlet excited light-emitting material. In the case where a light-emitting element which emits green light of which visibility is high, is also formed of the triplet excited light-emitting material, power consumption can be further reduced.

Light emitting layers having different light-emission wavelength bands may be formed in respective pixels so as to perform color display. Typically, light emitting layers corresponding to respective colors of R (red), G (green), and B (blue) are formed. In this case, color purity can be improved and specular reflection (glare) of a pixel portion can be prevented by providing a filter which transmits light of the light-emission wavelength band on a light emission side of the pixel. By providing the filter, a circular polarizing plate or the like, which has been conventionally considered to be required, can be omitted; thereby reducing loss of light emitted from the light emitting layer. Furthermore, a change in hue, which is caused when a pixel portion (display screen) is seen obliquely, can be reduced.

In a display device having the pixel configuration shown in FIG. 9, low power consumption can be achieved by combining with the display control circuit described in Embodiment Modes 1 to 4.

(Embodiment Mode 10)

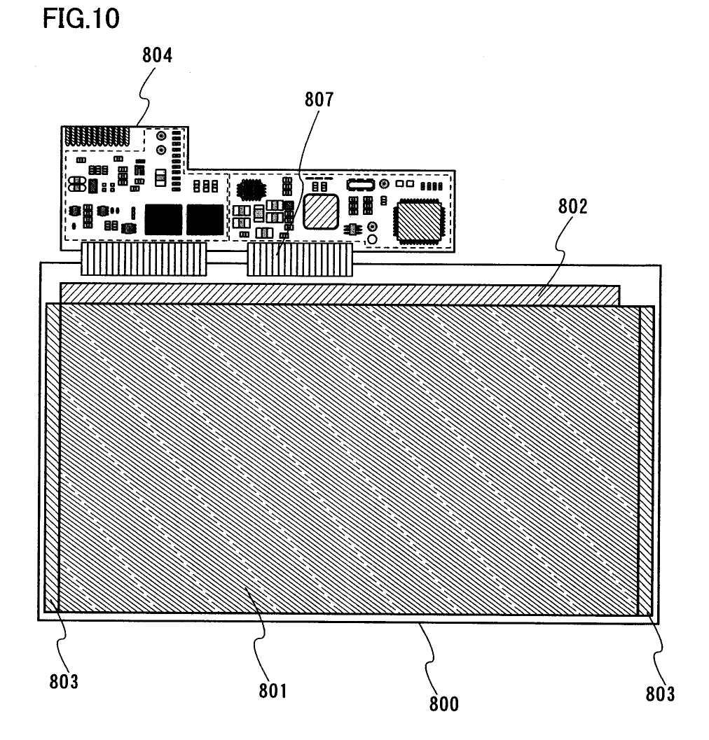

FIG. 10 shows a display module combined with a display panel 800 and a circuit substrate 804. In FIG. 10, the display control circuit described in Embodiment Modes 1 to 4 is formed over the circuit substrate 804. Signals outputted from these circuits formed over the circuit substrate 804 are inputted to the display panel 800 by a connection wire 807.

The display panel 800 has a pixel portion 801, a signal driver circuit 802, and a scan driver circuit 803, and this configuration shows one similar to FIG. 6B. Such a display module is incorporated and a display portion of various electronic apparatuses can be formed. That is, this embodiment mode can be combined with Embodiment Modes 1 to 9 freely.

(Embodiment Mode 11)

This embodiment mode describes an example of a mobile phone device as an electronic apparatus related to the invention.

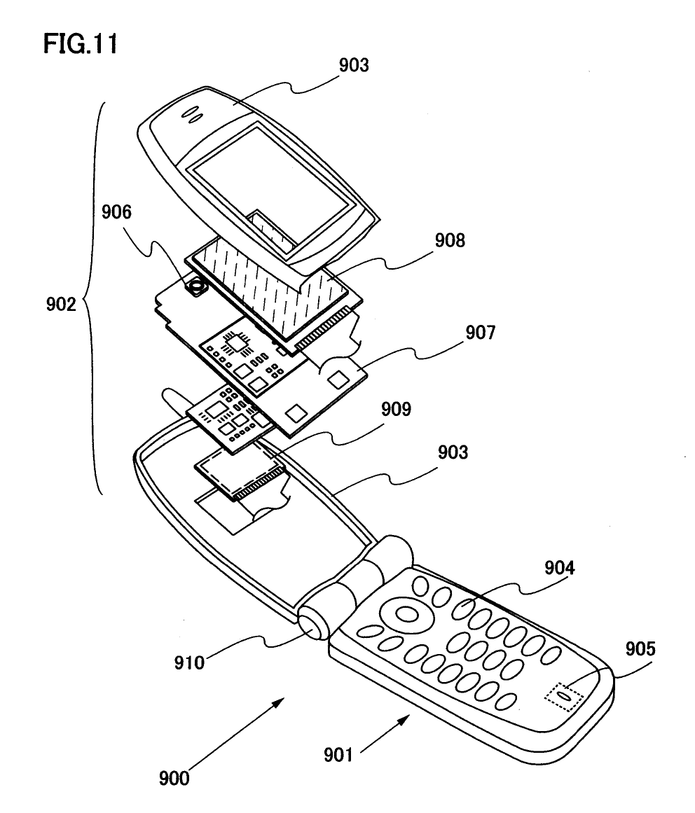

A mobile phone device 900 shown in FIG. 11 has a main body (A) 901 provided with an operating switch or the like 904, a microphone 905 and the like, and a main body (B) 902 provided with a display panel (A) 908, a display panel (B) 909, a speaker 906 and the like, which are connected to a hinge 910 to be openable and closable. The display panel (A) 908 and the display panel (B) 909 are incorporated in a housing 903 in the main body (B) 902 along with a circuit board 907. Pixel portions of the display panel (A) 908 and the display panel (B) 909 are arranged so as to be visible from an opening window formed in the housing 903.

The display panel (A) 908 and the display panel (B) 909 can appropriately set specifications such as the number of pixels in accordance with a function of the mobile phone device 900. For example, the display panel (A) 908 and the display panel (B) 909 can be combined by setting the display panel (A) 908 as a main screen and the display panel (B) 909 as a sub screen.

Then, the display panel (A) 908 can be a color display screen with high definition expressing a character or an image while the display panel (B) 909 can be a monochrome information display screen expressing text information. Particularly, the display panel (B) 909 can be an active matrix type with high definition so that various text information is displayed and information display density per display screen can be improved. For example, the display panel (A) 908 can be QVGA (320 dots×240 dots) of 64 gray scale levels, 260,000 colors at 2 to 2.5 inches, while the display panel (B) 909 can be a high definition panel of 180 to 220 ppi of 2 to 8 gray scale levels in monochrome, so that not only Roman character, hiragana, katakana but also Chinese character, Arabic alphabet or the like can be displayed.

The display panel (A) 908 and the display panel (B) 909 have a similar configuration to that of Embodiment Modes 6 to 10. Moreover, a display control circuit similar to that described in Embodiment Modes 1 to 5 is formed to the circuit board 907 connected to these display panels, which contributes to reduce power consumption of the mobile phone device 900. Accordingly, long continuous use is enabled. In addition, since a battery can be miniaturized, a mobile phone device can be reduced in weight.

A mobile phone device related to this embodiment mode can be changed in various modes in accordance with the function and application. For example, an image sensor is incorporated in a portion of the hinge 910 and a mobile phone device with a camera can be formed. Moreover, even by a configuration in which the operating switch or the like 904, the display panel (A) 908, and the display panel (B) 909 are incorporated in one housing, the aforementioned operation effect can be obtained. Moreover, even when the configuration of this embodiment mode is applied to an information display terminal provided with a plurality of display portions, a similar effect can be obtained.

(Embodiment Mode 12)

This embodiment mode shows an example of a TV set as an electronic apparatus related to the invention.

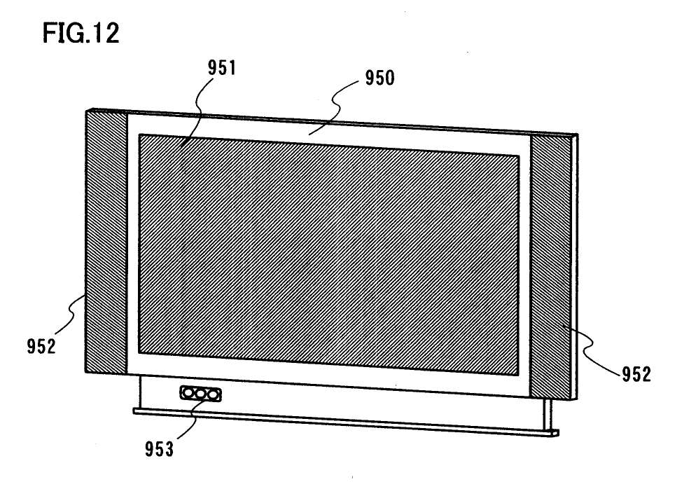

FIG. 12 shows a TV set related to the invention, including a main body 950, a display portion 951, speaker portions 952, an operating switch or the like 953, and the like. In this TV set, the display portion 951 has a configuration similar to that of Embodiment Modes 6 to 10. In addition, a display control circuit similar to that described in Embodiment Modes 1 to 5 is formed to the circuit board 907 connected to such a display panel. That is, a module structure similar to that shown in FIG. 10 is included, which contributes to reduce power consumption of the TV set.

This TV set does not have deterioration of image quality, and low power consumption is achieved. By such a characteristic, a power supply circuit can be greatly reduced or downsized in the TV set; therefore, reduction in size and weight or thickness of the main body 950 can be achieved. Moreover, by a TV set in which low power consumption, high image quality, and reduction in size and weight are achieved, a product adapted to the living environment can be provided.

This application is based on Japanese Patent Application serial no. 2005-121602 filed in Japan Patent Office on Apr. 19, in 2005, the entire contents of which are hereby incorporated by reference.

What is claimed is:

1. A display device comprising:
a main video data storage means for storing video data;
a display mode storage means for storing a display mode;
a display mode writing means by which the display mode of a supplied video signal is judged so that judged information is written to the display mode storage means;
a video signal reading means by which the video data is read from the main video data storage means so that the video data is supplied to a display panel;
a display mode reading means by which the display mode is read from the display mode storage means; and
a video signal writing means by which permission or prohibition of writing of the supplied video signal is judged based on the display mode read from the display mode reading means and the video signal is converted to video data which can express a gray scale and written to the main video data storage means.

2. The display device according to claim 1, wherein the video signal reading means includes a control means for prohibiting reading a video signal from the main video data storage means based on the judged information stored in the display mode storage means.

3. The display device according to claim 1, wherein the main video data storage means and the display mode storage means are formed over a same chip.

4. The display device according to claim 1, wherein the main video data storage means and the display mode storage means are formed over different chips.

5. The display device according to claim 1, wherein the supplied video data is compressed as an operation for judging the display mode in the display mode writing means and the display mode reading means.

6. The display device according to claim 1, wherein the display mode includes information of compressibility in the display mode writing means and the display mode reading means.

7. The display device according to claim 1, wherein one or a plurality of bits video data corresponding to one or a plurality of pixels are the same each other among the supplied video data, the display mode includes location information of the one or the plurality of pixels and one or the plurality of bits information in the display mode writing means and the display mode reading means.

8. The display device according to claim 1, wherein the display mode is judged using an exclusive OR circuit in the display mode writing means.

9. The display device according to claim 1, wherein the video data is written to a plurality of different regions based on compressibility of video data in the video data writing means.

10. The display device according to claim 9, wherein the plurality of regions are formed over a same chip.

11. The display device according to claim 9, wherein the plurality of regions are formed over different chips.

12. A display device comprising:
a storage means for storing video data and a display mode;
a display mode writing means by which the display mode of a supplied video signal is judged so that judged information is written to the storage means;
a video signal reading means by which the video data is read from the storage means so that the video data is supplied to a display panel;
a display mode reading means by which the display mode is read from the storage means; and
a video signal writing means by which permission or prohibition of writing of the supplied video signal is judged based on the display mode read from the display mode reading means and the video signal is converted to video data which can express a gray scale and written to the storage means.

13. The display device according to claim 12, wherein the video signal reading means includes a control means for prohibiting reading a video signal from the storage means based on the judged information stored in the storage means.

14. The display device according to claim 12, wherein the supplied video data is compressed as an operation for judging the display mode in the display mode writing means and the display mode reading means.

15. The display device according to claim 12, wherein the display mode includes information of compressibility in the display mode writing means and the display mode reading means.

16. The display device according to claim 12, wherein one or a plurality of bits video data corresponding to one or a plurality of pixels are the same each other among the supplied video data, the display mode includes location information of the one or the plurality of pixels and one or the plurality of bits information in the display mode writing means and the display mode reading means.

17. The display device according to claim 12, wherein the display mode is judged using an exclusive OR circuit in the display mode writing means.

18. The display device according to claim 12, wherein the video data is written to a plurality of different regions based on compressibility of video data in the video data writing means.

19. The display device according to claim 18, wherein the plurality of regions are formed over a same chip.

20. The display device according to claim 18, wherein the plurality of regions are formed over different chips.

21. A display device comprising:
a main video data storage means for storing video data;
a display mode storage means for storing a display mode;
a display mode writing means by which the display mode of a supplied video signal is judged so that judged information is written to the display mode storage means;
a reading means by which the video data is read from the main video data storage means so that the video data is supplied to a display panel and the display mode is read from the display mode storage means; and
a video signal writing means by which permission or prohibition of writing of the supplied video signal is judged based on the display mode read from the reading means and the video signal is converted to video data which can express a gray scale and written to the main video data storage means.

22. The display device according to claim 21, wherein the reading means includes a control means for prohibiting reading a video signal from the main video data storage means based on the judged information stored in the display mode storage means.

23. The display device according to claim 21, wherein the main video data storage means and the display mode storage means are formed over a same chip.

24. The display device according to claim 21, wherein the main video data storage means and the display mode storage means are formed over different chips.

25. The display device according to claim 21, wherein the supplied video data is compressed as an operation for judging the display mode in the display mode writing means and the reading means.

26. The display device according to claim 21, wherein the display mode includes information of compressibility in the display mode writing means and the reading means.

27. The display device according to claim 21, wherein one or a plurality of bits video data corresponding to one or a plurality of pixels are the same each other among the supplied video data, the display mode includes location information of the one or the plurality of pixels and one or the plurality of bits information in the display mode writing means and the reading means.

28. The display device according to claim 21, wherein the display mode is judged using an exclusive OR circuit in the display mode writing means.

29. The display device according to claim 21, wherein the video data is written to a plurality of different regions based on compressibility of video data in the video data writing means.

30. The display device according to claim 29, wherein the plurality of regions are formed over a same chip.

31. The display device according to claim 29, wherein the plurality of regions are formed over different chips.

32. A display device comprising:
a storage means for storing video data and a display mode;
a display mode writing means by which the display mode of a supplied video signal is judged so that judged information is written to the storage means;
a reading means by which the video data is read from the storage means so that the video data is supplied to a display panel and the display mode is read from the storage means; and
a video signal writing means by which permission or prohibition of writing of the supplied video signal is judged based on the display mode read from the reading means and the video signal is converted to video data which can express a gray scale and written to the storage means.

33. The display device according to claim 32, wherein the reading means includes a control means for prohibiting reading a video signal from the storage means based on the judged information stored in the storage means.

34. The display device according to claim 32, wherein the supplied video data is compressed as an operation for judging the display mode in the display mode writing means and the reading means.

35. The display device according to claim 32, wherein the display mode includes information of compressibility in the display mode writing means and the reading means.

36. The display device according to claim 32, wherein one or a plurality of bits video data corresponding to one or a plurality of pixels are the same each other among the supplied video data, the display mode includes location information of the one or the plurality of pixels and one or the plurality of bits information in the display mode writing means and the reading means.

37. The display device according to claim 32, wherein the display mode is judged using an exclusive OR circuit in the display mode writing means.

38. The display device according to claim 32, wherein the video data is written to a plurality of different regions based on compressibility of video data in the video data writing means.

39. The display device according to claim 38, wherein the plurality of regions are formed over a same chip.

40. The display device according to claim 38, wherein the plurality of regions are formed over different chips.

41. A display device comprising:
a main video data storage means for storing video data;
a display mode storage means for storing a display mode;
a display mode writing means by which the display mode of a supplied video signal is judged so that judged information is written to the display mode storage means; and
a video signal writing means by which permission or prohibition of writing of the supplied video signal is judged based on the display mode and the video signal is converted to video data which can express a gray scale and written to the main video data storage means.

42. The display device according to claim 41, wherein the main video data storage means and the display mode storage means are formed over a same chip.

43. The display device according to claim 41, wherein the main video data storage means and the display mode storage means are formed over different chips.

44. The display device according to claim 41, wherein the supplied video data is compressed as an operation for judging the display mode in the display mode writing means.

45. The display device according to claim 41, wherein the display mode includes information of compressibility in the display mode writing means.

46. The display device according to claim 41, wherein one or a plurality of bits video data corresponding to one or a plurality of pixels are the same each other among the supplied video data, the display mode includes location information of the one or the plurality of pixels and one or the plurality of bits information in the display mode writing means.

47. The display device according to claim 41, wherein the display mode is judged using an exclusive OR circuit in the display mode writing means.

48. The display device according to claim 41, wherein the video data is written to a plurality of different regions based on compressibility of video data in the video data writing means.

49. The display device according to claim 48, wherein the plurality of regions are formed over a same chip.

50. The display device according to claim 48, wherein the plurality of regions are formed over different chips.
